(19) United States
(12) Patent Application Publication
(10) Pub. No.: US 2014/0160353 A1
(43) Pub. Date: Jun. 12, 2014

(54) CONTROL APPARATUS, REMOTE CONTROL APPARATUS, AND METHOD CAPABLE OF CONTROLLING TV INTERFACE

(71) Applicants: YA-FANG LI, Shenzhen (CN); CHIH-SAN CHIANG, New Taipei (TW); HUA-DONG CHENG, Shenzhen (CN); HAI-SEN LIANG, Shenzhen (CN); TE-JIA LIU, Shenzhen (CN); LING-JUAN JIANG, Shenzhen (CN)

(72) Inventors: YA-FANG LI, Shenzhen (CN); CHIH-SAN CHIANG, New Taipei (TW); HUA-DONG CHENG, Shenzhen (CN); HAI-SEN LIANG, Shenzhen (CN); TE-JIA LIU, Shenzhen (CN); LING-JUAN JIANG, Shenzhen (CN)

(21) Appl. No.: 13/728,920

(22) Filed: Dec. 27, 2012

(30) Foreign Application Priority Data
Dec. 6, 2012 (CN) 201210517736.7

(51) Int. Cl. H04N 5/44

(52) U.S. Cl. CPC H04N 5/4403
USPC 348/563

(57) ABSTRACT

A control apparatus capable of controlling a TV interface communicates with a TV and a remote control apparatus. The control apparatus includes a communicating unit, a storage unit, and a control unit. When the communicating unit receives a wireless signal carrying information of a selected executable program transmitted by the remote control apparatus, the control unit obtains an executable program from the storage unit according to the information carried by the wireless signal and generates a first control signal and a second control signal. The remote control apparatus provides a remote control interface corresponding to the selected executable program in response to the first control signal. The TV executes the selected executable program and provides an operation interface corresponding to the selected executable program in response to the second signal. A related method is also provided.

### BACKGROUND

1. Technical Field

The present disclosure relates to a technology of TV telecontrolling and, particularly, to a control apparatus, a remote control apparatus, and a method capable of controlling a TV interface.

2. Description of the Related Art

Users commonly use remote control apparatus to choose and change television (TV) functions such as from TV reception to a computer game. However, the user needs to operate a plurality of buttons mounted on the remote control apparatus to interact with the different functions which can be complex and confusing for the users. Furthermore, the buttons mounted on the remote control apparatus do not allow for intuitive command input for such things as a car racing game.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosures. Moreover, in the drawings, like reference numerals designate corresponding parts throughout the several views.

FIG. 1 is a block diagram of a system capable of controlling a TV interface in accordance with an exemplary embodiment.

FIG. 2 is a first use state diagram of the system of FIG. 1.

FIG. 3 is a second use state diagram of the system of FIG. 1.

FIG. 4 is a flowchart of a method capable of controlling TV interface in accordance with an exemplary embodiment.

### DETAILED DESCRIPTION

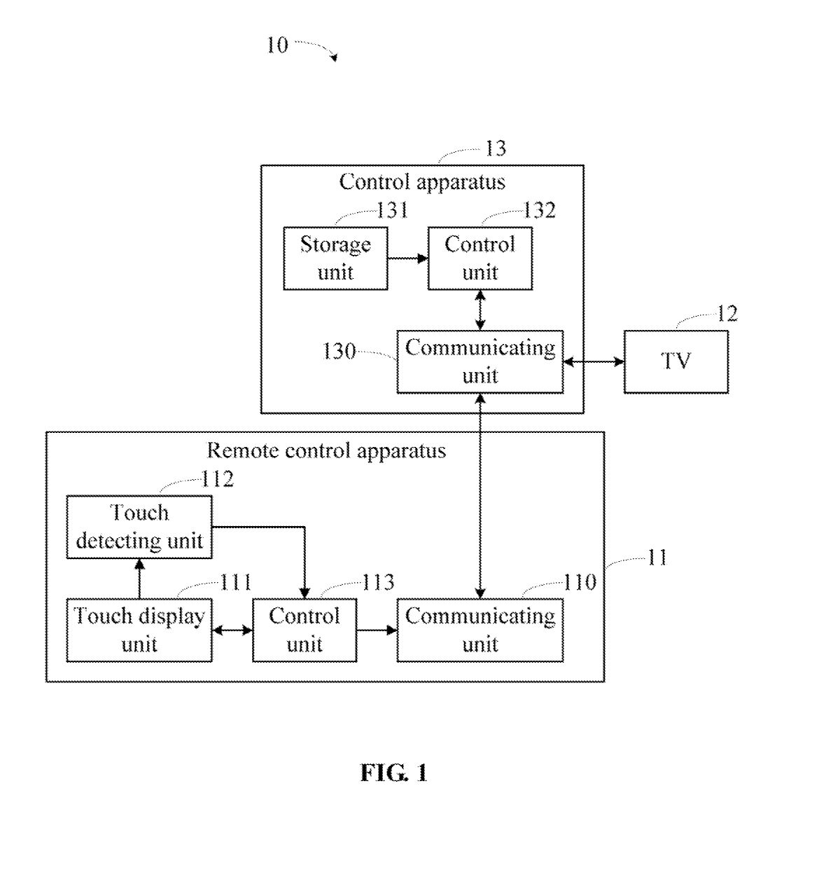

Referring to FIGS. 1-3, a system capable of controlling a TV on-screen interface is employed in accordance with an exemplary embodiment. The system 10 includes a remote control apparatus 11, a TV set 12, and a control apparatus 13. The remote control apparatus 11 and the TV set 12 communicate with the control apparatus 13 via a network. In the embodiment, the control apparatus 13 is a set-top box. The remote control apparatus 11 is a mobile terminal.

The remote control apparatus 11 includes a communicating unit 110, a touch display unit 111, a touch detecting unit 112, and a control unit 113. The communicating unit 110 is configured for communicating with the control apparatus 13. The touch display unit 111 is configured for generating touch signals when being touched by a user. The control unit 113 controls the touch display unit 111 to display a first remote control interface of the remote control apparatus 11.

The touch detecting unit 112 detects the touch signal generated by the touch display unit 111 when being touched, and determines touch position according to the touch signal. The control unit 113 generates a mode changing request signal when determining to change working mode of the TV set 12 according to the touch position, and controls the communicating unit 110 to transmit the mode change request signal to the control apparatus 13. In the embodiment, the working mode of the TV set 12 includes a normal mode and a smart mode. The TV set 12 broadcasts TV programs when in the normal mode, and executes an executable program selected by the user and displays an operation interface corresponding to the selected executable program when in the smart mode.

In the embodiment, the first remote control interface displays a plurality of icons of buttons of the remote control apparatus 11, one of the icons is “TV/iTV.” The user touches the icon “TV/iTV” to change the normal mode to the smart mode, or change the smart mode to the normal mode. The control unit 113 generates the mode changing request signal when the current working mode of the TV set 12 is the normal mode, and generates another mode changing request signal when the current working mode of the TV set 12 is the smart mode.

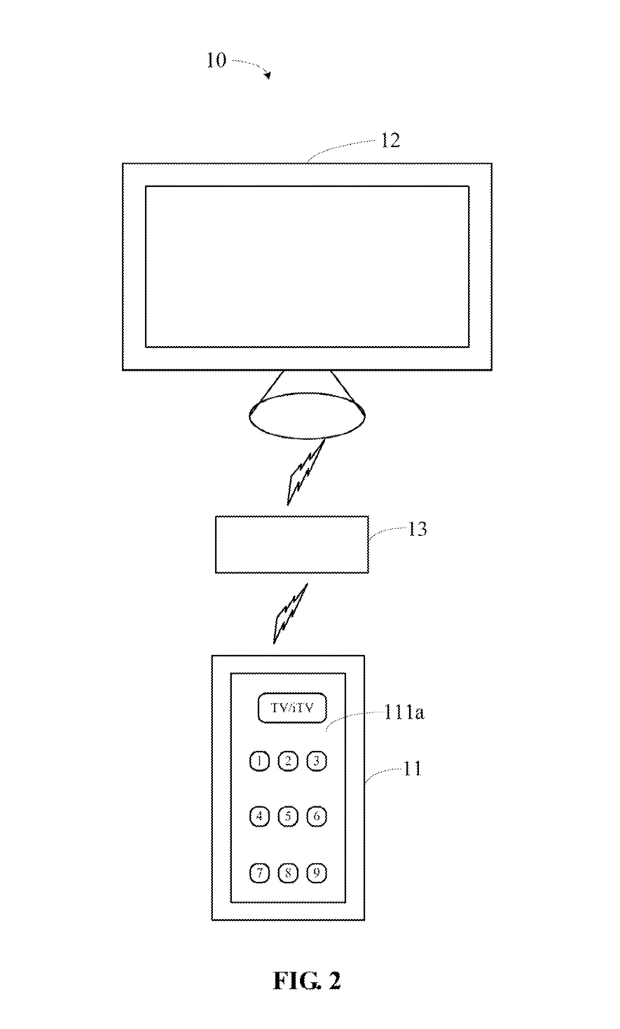

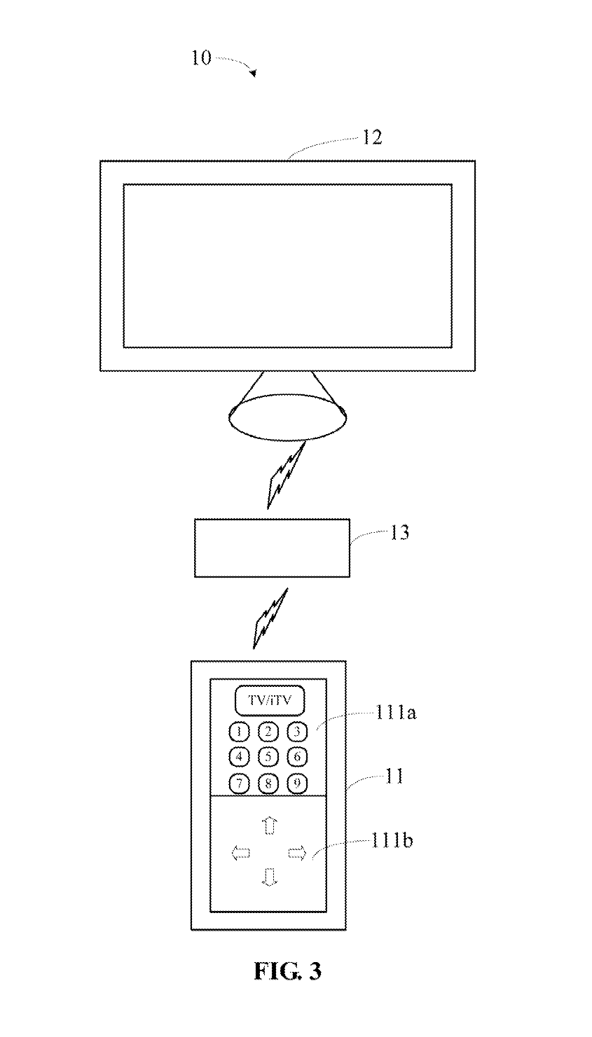

In the embodiment, the control unit 113 controls the touch display unit 111 to display a first display area 111a and a second display area 111b at the same time. The control unit 113 controls the first display area 111a to combine with the second display area 111b to cooperatively display the first remote control interface when the TV set 12 is in the normal mode (as shown in FIG. 2). The control unit 113 controls the first display area 111a to display the first remote control interface and the second display area 111b to display a second remote control interface when the TV is in the smart mode (as shown in FIG. 3). The second remote control interface corresponds to the operating interface provided by the TV set 12 when the selected executable program is executed by the TV set 12.

The control apparatus 13 includes a communicating unit 130, a storage unit 131, and a control unit 132. The communicating unit 130 receives the mode changing request signal transmitted from the remote control apparatus 11. The control unit 132 generates a mode changing control signal in response to the received mode changing request signal, and controls the communicating unit 130 to transmit the mode changing control signal to the TV set 12. The TV set 12 is changed to the smart mode or the normal mode in response to the mode changing control signal, and displays the corresponding operation interface.

The storage unit 131 is configured for storing a plurality of executable programs. When the TV set 12 is changed to the smart mode, the control unit 113 obtains information of the plurality of executable programs from the storage unit 131 via the communicating unit 110, and controls the touch display unit 111 to display a list of the obtained information of the plurality of executable programs on the first remote control interface. The touch detecting unit 112 determines touch position when the list is touched by a user. The control unit 113 determines the selected executable program according to the touch position determined by the touch detecting unit 112, generates a selecting signal correspondingly, and controls the communicating unit 110 to transmit the selecting signal to the control apparatus 13. The selecting signal includes information of the selected executable program, such as a name of the executable program.

When the control apparatus 13 receives the selecting signal transmitted by the remote control apparatus 11, the control unit 132 obtains the executable program from the storage unit 131 in response to the selecting signal, and generates a first control signal and a second control signal. The control unit 132 controls the communicating unit 130 to transmit the first control signal to the remote control apparatus 11, and transmit the second control signal to the TV set 12.

When the remote control apparatus 11 receives the first control signal transmitted by the control apparatus 13, the control unit 113 controls the touch display unit 111 to display the first display area 111a and the second display area 111b thereon, and further controls the touch display unit 111 to display the first remote control interface on the first display area 111a and display the second remote control interface on the second display area 111b. In an alternative embodiment, the control unit 113 controls the touch display unit 111 to display the second remote control interface only.

When the TV set 12 receives the second control signal transmitted by the remote control apparatus 11, the TV set 12 runs the selected executable program and displays the operating interface corresponding to the selected executable program, which is controlled remotely via operating the second remote control interface displayed on the remote control apparatus 11. The second remote control interface is configured to be user-friendly by providing input choices that directly correspond to the onscreen operating interface for any particular selected executable program.

In the embodiment, when the TV set 12 runs a selected executable program, if the control unit 132 receives a wireless signal from the remote control apparatus 11, the control unit 132 determines whether the wireless signal is a selecting signal carrying information such as a name of a selected executable program. If the wireless signal is a selecting signal carrying information of a selected executable program, the control unit 132 determines whether the information of the selected executable program carried by the wireless signal matches that of the executable program running in the TV set 12. When the information of the selected executable carried by the wireless signal does not match the running executable program in the TV set 12, the control unit 132 obtains an executable program from the storage unit 132 corresponding to the information carried by the wireless signal (hereinafter “the new executable program”), generates the first control signal and the second control signal, and controls the communicating unit 130 to transmit the first control signal to the remote control apparatus 11 to update the second remote control interface corresponding to the new executable program and transmit the second control signal to the TV set 12 to run the new executable program and update the operating interface on the TV set 12 accordingly.

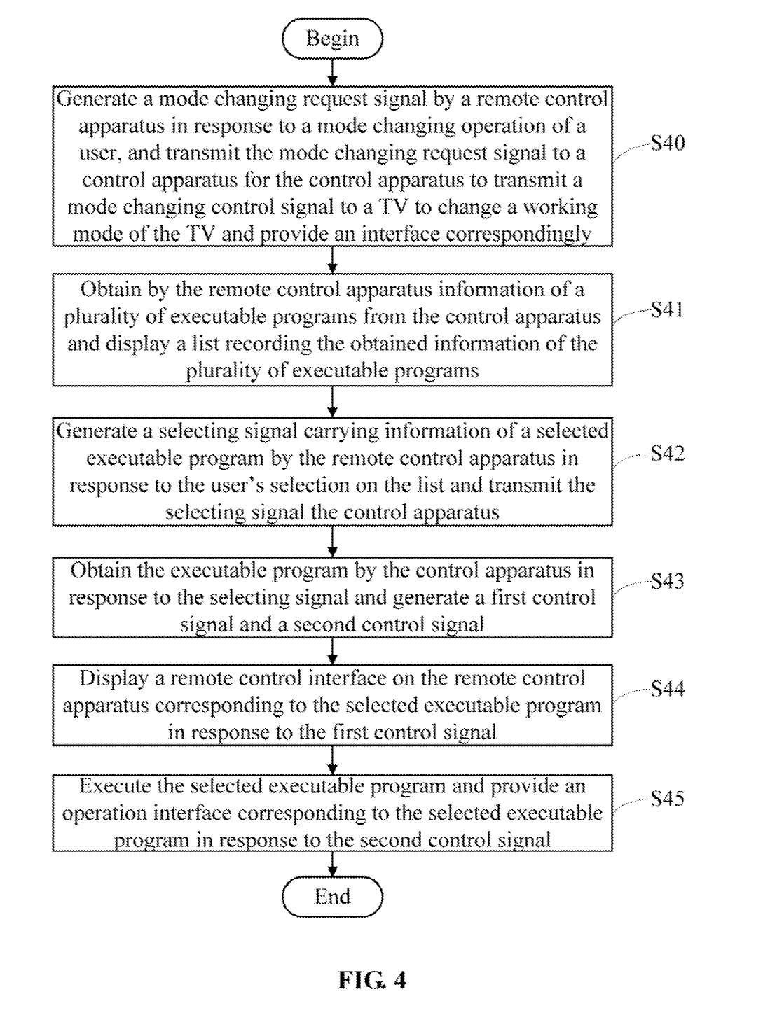

FIG. 4 is a flowchart of a method capable of controlling TV interface.

In step S40, the touch detecting unit 112 detects the touch signal generated by the touch display unit 111 when being touched, and determines touch position according to the touch signal. The control unit 113 generates the mode changing request signal when determining to change working mode of the TV set 12 according to the touch position, and controls the communicating unit 110 to transmit the mode change request signal to the control apparatus 13. The control unit 132 generates the mode changing control signal in response to the received mode changing request signal, and controls the communicating unit 130 to transmit the mode changing control signal to the TV set 12. The TV set 12 is changed to the smart mode or the normal mode in response to the mode changing control signal, and displays the corresponding operation interface.

The TV set 12 broadcasts TV programs in the normal mode, and runs an executable program such as a music player or game selected by the user and displays an operation interface corresponding to the selected executable program when in the smart mode.

In the embodiment, the first remote control interface displays a plurality of icons of buttons of the remote control apparatus 11, including an icon “TV/iTV”. The user touches the icon “TV/iTV” to change the normal mode to the smart mode, or change the smart mode to the normal mode. The control unit 113 generates the mode changing request signal when the current working mode of the TV set 12 is the normal mode, and generates another mode changing request signal when the current working mode of the TV set 12 is the smart mode.

In step S41, the control unit 113 obtains the information of the plurality of executable programs from the storage unit 131 via the communicating unit 110, and controls the touch display unit 111 to display the list recording the obtained information of the plurality of executable programs on the first remote control interface.

In step S42, the touch detecting unit 112 determines touch position when the list is touched by a user. The control unit 113 determines the selected executable program according to the touch position determined by the touch detecting unit 112, generates the selecting signal correspondingly, and controls the communicating unit 110 to transmit the selecting signal to the control apparatus 13.

The selecting signal includes information of the selected executable program, such as a name of the executable program.

In step S43, the control unit 132 obtains the executable program from the storage unit 131 in response to the selecting signal, and generates the first control signal and the second control signal.

In step S44, the control unit 113 controls the touch display unit 111 to display the first display area 111a and the second display area 111b thereon, and further controls the touch display unit 111 to display the first remote control interface on the first display area 111a and display the second remote control interface on the second display area 111b.

In an alternative embodiment, the control unit 113 controls the touch display unit 111 to display the second remote control interface only.

In step S45, the TV set 12 executes the selected executable program and provides the operation interface corresponding to the selected executable program, which is controlled remotely via operating the second remote control interface displayed on the remote control apparatus 11.

In the embodiment, when the TV set 12 runs the selected executable program, if the control unit 132 receives a wireless signal from the remote control apparatus 11, the control unit 132 determines whether the wireless signal is a selecting signal carrying information such as a name of a selected executable program. If the wireless signal is a selecting signal carrying information of a selected executable program, the control unit 132 determines whether the information of the selected executable program carried by the wireless signal matches that of the executable program running in the TV set 12. When the information of the selected executable carried by the wireless signal does not match the running executable program in the TV set 12, the control unit 132 obtains an executable program from the storage unit 132 corresponding to the information carried by the wireless signal (hereinafter “the new executable program”), generates the first control signal and the second control signal, and controls the communicating unit 130 to transmit the first control signal to the remote control apparatus 11 to update the second remote control interface corresponding to the new executable program and transmit the second control signal to the TV set 12 to run the new executable program and update the operating interface on the TV set 12 accordingly.

It is understood that the present disclosure may be embodied in other forms without departing from the spirit thereof. Thus, the present examples and embodiments are to be considered in all respects as illustrative and not restrictive, and the disclosure is not to be limited to the details given herein.

1. A control apparatus capable of controlling TV interface, wherein the control apparatus is configured to communicate with a TV and a remote control apparatus, the control apparatus comprising:
a communicating unit configured for receiving a mode changing request signal transmitted by the remote control apparatus in response to a mode changing operation of a user, and further configured for receiving a wireless signal transmitted by the remote control apparatus in response to an executable program selecting operation of the user on the remote control apparatus, the wireless signal carrying information of a selected executable program;
a storage unit configured for storing a plurality of executable programs;
a control unit configured for generating a mode changing control signal in response to the received mode changing request signal, controlling the communicating unit to transmit the mode changing control signal to the TV for the TV to change a working mode; and further configured for obtaining an executable program from the storage unit according to the information carried by the wireless signal, generating a first control signal and a second control signal, and controlling the communicating unit to transmit the first control signal to the remote control apparatus for the remote control apparatus to display a remote control interface corresponding to the selected executable program, and transmit the second control signal to the TV for the TV to run the selected executable program and display an operation interface corresponding to the selected executable program.

2. The control apparatus capable of controlling TV interface as recited in claim 1, wherein the control apparatus is a set top box.

3. The control apparatus capable of controlling TV interface as recited in claim 1, wherein the control unit is further configured for determining whether the wireless signal transmitted by the remote control apparatus carries information of a selected executable program when the TV runs the selected executable program, determining whether the information carried by the wireless signal matches the information of the running executable program if the wireless signal carries the information of a selected executable program, obtaining the executable program from the storage unit corresponding to the information carried by the wireless signal if the information carried by the wireless signal does not match the information of the running executable program executed by the TV, and generating the first control signal and the second control signal.

4. A remote control apparatus capable of controlling TV interface, wherein the remote control apparatus is configured to communicate with a control apparatus, and configured for controlling a TV set remotely, the remote control apparatus comprising:
a communicating unit configured for communicating with the control apparatus;
a touch display unit configured for displaying a first remote control interface including a plurality of button icons of the remote control apparatus for user to select, and further configured for generating touch signals in response to touch operation of a user;
a touch detecting unit configured for determining a touch position according to the touch signals;
a control unit configured for generating a mode changing request signal when determining to change working mode of the TV set according to the touch position determined by the touch detecting unit, and controlling the communicating unit to transmit the mode changing request signal to the control apparatus for the control apparatus to transmit a mode changing controls signal to the TV set to change a working mode of the TV; and further configured for determining a selected executable program when determining to select an executable program according to the touch position determined by the touch detecting unit, generating a wireless signal carrying information of the selected executable program, and controlling the communicating unit to transmit the wireless signal to the control apparatus for the control apparatus to obtain the selected executable program and feedback a first control signal to the remote control apparatus, wherein the control unit is configured to control the touch display unit to display a second remote control interface corresponding to the selected executable program in response to the first control signal.

5. The remote control apparatus capable of controlling TV interface as recited in claim 4, wherein the control unit is further configured for controlling the touch display unit to display a first display area and a second display area at the same time, and controlling the first display area to display the first remote control interface and the second display area to display the second remote control interface.

6. The remote control apparatus capable of controlling TV interface as recited in claim 4, wherein the control unit is further configured for obtaining a list recording information of a plurality of executable programs stored in the control apparatus through the communicating unit in the step of generating the mode changing request signal, and controlling the touch display unit to display the list on the first remote control interface for a user to select an executable program.

7. The remote control apparatus capable of controlling TV interface as recited in claim 4, wherein the working mode of the TV comprises a normal mode and a smart mode, the TV broadcasts TV programs in the normal mode, and executes an executable program selected by the user and displays the operation interface corresponding to the selected executable program in the smart mode.

8. A method capable of controlling TV interface employed in a system, wherein the system includes a remote control apparatus, a TV, and a control apparatus, the control apparatus communicates with the remote control apparatus and the TV, the method comprising:
generating a mode changing request signal using the remote control apparatus in response to a mode changing operation of a user, and transmitting the mode changing request signal to the control apparatus for the control apparatus to transmit a mode changing control signal to the TV to change a working mode of the TV and display an interface correspondingly;
transmitting a wireless signal carrying information of a selected executable program to the control apparatus in response to an executable program selecting operation of the user on the remote control apparatus;
obtaining the executable program by the control apparatus corresponding to the information carried by the wireless signal and generating a first control signal and a second control signal;
displaying a remote control interface on the remote control apparatus corresponding to the selected executable program in response to the first control signal; and
running the selected executable program and displaying an operation interface corresponding to the selected executable program in response to the second control signal on the TV set.

9. The method as recited in claim 8, further comprising:
obtaining a list recording a plurality of executable programs from the control apparatus using the remote control apparatus, and determining the selected executable program using the remote control apparatus in response to a user's selection on the list.

10. The method as recited in claim 8, further comprising:
displaying a first display area and a second display area using the remote control apparatus in response to the first control signal, wherein the first display area is configured for displaying a remote control interface including a plurality of button icons of the remote control apparatus, the second display area is configured for displaying the remote control interface corresponding to the executable selected programs.

11. The method as recited in claim 8, further comprising:
determining whether the wireless signal carries information of a selected executable program transmitted by the remote control apparatus using the control apparatus;
determining whether the information carried by the wireless signal matches the information of the executable program executed by the TV; and
obtaining an executable program using the control apparatus corresponding to the information carried by the wireless signal if the information carried by the wireless signal does not match the information of the executable program running in the TV and generating the first control signal and the second control signal.
